(19) United States
(12) Patent Application Publication
(10) Pub. No.: US 2007/0256968 A1
(43) Pub. Date: Nov. 8, 2007

(54) ADVANCED FILTER FOR BOILERS

(75) Inventor: Domenico Bertollo, Pianezze San Lorenzo (IT)

Correspondence Address: BROWDY AND NEIMARK, P.L.L.C.;624 NINTH STREET, NW, SUITE 300, WASHINGTON, DC, 20001-5303, US

(73) Assignee: BMI Bertollo S.r.L., Pianezze San Lurenzo (VI) (IT)

(21) Appl. No.: 11/741,444

(22) Filed: Apr. 27, 2007

(30) Foreign Application Priority Data
Apr. 28, 2006 (IT) PD 2006A000167

(51) Int. Cl. B01D 27/00

(52) U.S. Cl. 210/459

(57) ABSTRACT

Advanced filter for boilers of domestic appliances such as irons, steam generators, humidifiers or others formed by a container holding a compartment able to receive a filtering cartridge in a provided seat at its interior. From the bottom of the container, there is an elongated hollow section, comprising an opening for the exit of demineralised liquid at the free end. A removably associable closing lid is provided, connected to the opening of the container and a central opening with a rubber adaptor in order to connect the top of an upside down bottle to the filter, in order to introduce the water into the compartment of the container and then into the tank of the boiler of the used appliance.

### FIELD OF APPLICATION

This invention concerns an advanced filter for boilers.

The filter in question is purposefully created to fill up the tanks with water in domestic appliances such as in particular irons, steam generators, humidifiers, steam cleaners and others.

In particular, the purpose of the filter to which this invention applies is to remove mineral salts from the water used in the tanks in order to ensure a more efficient and lasting performance of the appliances with boilers.

### PRIOR ART

It is a well known fact that the mineral salts naturally dissolved in water have a tendency to deposit on the surfaces they come in contact with; this is especially the case in appliances that use hot water or steam, where the correct functioning of such appliances could be hindered due to the build up of mineral salts. These deposits do not only block the pipes and other parts, such as the steam holes, but also reduce the thermal efficiency of the surfaces on which they build up. In order to avoid such deposits, the appliances with a boiler for the production of steam, such as irons, use demineralised water obtained by filtering the water beforehand in order to remove the dissolved mineral salts. Once the water has been demineralised, it is necessary to pour it into the tanks that feed the boilers. Water tanks can be pressurised and in this case they are normally made of metal and have a pressure cap that must be closed tightly after the refilling of the tank; alternatively they can work at atmospheric pressure and in such case they are generally made of plastic and connected to a pump to provide the required quantity of water to the boiler, this being normally made up of a metallic tank with associated electrical elements to generate heat.

In any case the filters currently available on the market require a two phase operation, firstly filtering the water and then filling up the tank; these operations are carried out separately and with substantial drawbacks both for the time delay required before the re-use of the appliance and for the impracticality of the two distinct operations. It is a well known fact that once the water has been filtered it is necessary to transfer it into the tank ensuring that it does not spill out from the tank opening.

There is in fact already available on the market a separate container with two separate compartments, one above the other, including a splash plate provided with an opening to insert the cartridge filter. The water is First of all poured into the top compartment in order for it to pass through the filter until it reaches the compartment below. The latter is provided with a spout used to pour the water into the feeding tank of the boiler.

This known type of filter has not proved to be very practical or functional.

There are many other known solutions available on the market to fill the tanks of the boilers with demineralised water, but they always require two separate operations, first the filtering and then the pouring out of the water. The latter operation can, for example, be carried out with the aid of a funnel in order to channel the required amount of demineralised water, obtained by purchasing a bottle of previously filtered water or by filtering the water with resin based systems or other methods, from a container to the tank.

On the market there are also other available solutions, which require that the filter be placed directly inside the tanks of the boilers, as described for example in patent EP 588164, or rather directly in the irons, as described for example in U.S. Pat. No. 5,526,595. However, these solutions have turned out to be of little practicality and expensive to produce.

### PRESENTATION OF THE INVENTION

The main purpose of this invention is therefore to eliminate the drawbacks of the above mentioned filters, offering an advanced filter for boilers, which allows the concentration of the two operations of filtering and filling up of the tank of the boiler into just one operation.

Another purpose of this invention is to offer an extremely practical filter to be used to fill up the boiler with demineralised water.

A further purpose of this invention is to offer a filter of simple construction, economical and completely reliable from the operational point of view.

These purposes along with many others are all achieved by the advanced filter, the subject of this invention, for boilers, in particular for domestic appliances such as irons, steam generators, humidifiers and others.

According to this invention the filter stands out due to the fact that it comprises a container with an opening, a compartment able to accommodate inside it a filtering cartridge (anti-scale cartridge), of an elongated hollow section, linked to the compartment, forming a channel extending from the bottom of the container to the filtering cartridge, comprising an opening for the exit of demineralised liquid at the free end as well as a removable closing lid connected to the opening of the container, with an opening to introduce the liquid into said container.

### BRIEF DESCRIPTION OF THE DRAWINGS

The technical specifications of this invention, according to the above mentioned purposes, are clearly understood from the content of the claims cited below and the advantages of the invention will become more evident through the detailed descriptions that follow, compiled with reference to the attached drawings, which merely represent one non-limiting example of its production, in which:

FIG. 1 shows a first perspective view of an advanced filter for boilers, the subject of this invention, connected to a bottle, and mounted on a steam generating appliance for an iron;

FIG. 2 shows a second perspective view of the filter in FIG. 1, with a bottle attached and mounted on the same steam generating appliance;

FIG. 3 shows a first sectional view where some of the parts have been removed in order to better highlight other parts of the filter and of the appliance of the previous figures;

FIGS. 4 and 5 show two enlarged details of FIG. 3;

FIG. 6 shows a second sectional view of a portion of the filter and of the appliance in the preceding figures;

FIG. 7 shows a detail of the filter in FIG. 1 in a perspective view relating to a container;

FIG. 8 shows a sectional view of the container in FIG. 7:

FIG. 9 shows a detail of the filter in FIG. 1 in a perspective view, relating to the closing lid of the container:

FIG. 10 shows a section view of the closing lid in FIG. 9;

FIG. 11 shows a detail of the filter in FIG. 1 in a perspective view;

FIG. 12 shows a sectional view of the seal in FIG. 11.

### DETAILED DESCRIPTION OF A PREFERRED EMBODIMENT

With reference to the attached drawings, the advanced filter for boilers, which is the subject of this invention, is referred to as (1).

It is meant to be used to fill the tanks of boilers of any appliance, in particular for domestic use such as irons, steam generators and others, with demineralised water.

In the attached figures an example of the filter (1) is cited according to this invention operationally connected to the boiler (A) of an iron. It must be understood, however, that the claimed filter (1) can be attached to other appliances, without leaving the area of protection of this patent.

The filter essentially comprises a container (2), basically of circular shape obtained by the moulding of plastic, preferably transparent, which, has a compartment (4) accessible via an above opening (3).

Inside the compartment (4), a further seat (5) is created through a stepped-up narrowing in order to seat a filtering cartridge (6) with a ring (7) which can be placed on the above mentioned step.

Starting from the bottom (9) of the container (2) in an off-centred position, there is a projection, away from the filtering cartridge (6), an elongated hollow channel shaped passage (8), with a higher conical portion (8′) tapered from the bottom (9) and with a lower basically cylindrical portion (8″), which is a continuation of the higher portion (8′). The lower portion (8″) comprises at its free end (10) an opening to allow for the liquid that has been demineralised by the Filtering cartridge (6) to fill the tank of a given appliance (A).

The filtering cartridge is filled with appropriate materials in order to remove the mineral salts dissolved in the water (for example resins) and should be replaced from time to time.

The filtering cartridge (6) is not the object of a specific claim and is notably provided with a lateral impermeable wall and a permeable upper and lower wall in order to allow the water to pass through with the subsequent filtering of the mineral salts.

The filtering cartridge (6) has the added advantage of changing colour, this being visible through the transparent plastic of the container (2) in order to indicate its state of use.

At the opening of the container (2) a removable closing lid (11) is connected with screws—nut screw connectors (12) produced with a male thread (12′) on the upper external edge of the container (2) connectable to a female thread (12″) on the lower internal edge of the lid (11).

The closing lid (11) has the added advantage of having small wings (20), which extend from top to bottom starting from the higher narrow portion, inside the container, in order to hold the filtering cartridge (6) in its seat.

The seal between the lid (11) and the container is guaranteed by an o-ring (21) preferably placed in a ring housing situated on the upper edge of the container (2).

Above the lid (11) in a central position, there is an opening (13) created in order to introduce the liquid to be demineralised in the compartment of the container (2).

As a further advantage, there is a seal in rubber (14) or other similar material formed by a hollow ring anchored to the lid (11) within the mouth of the opening (13).

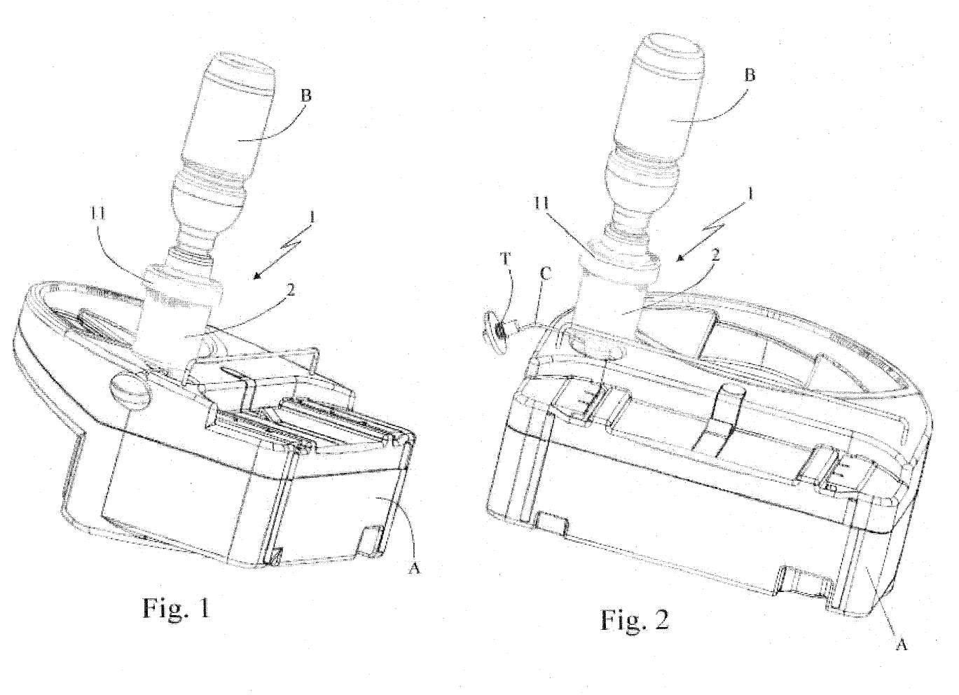

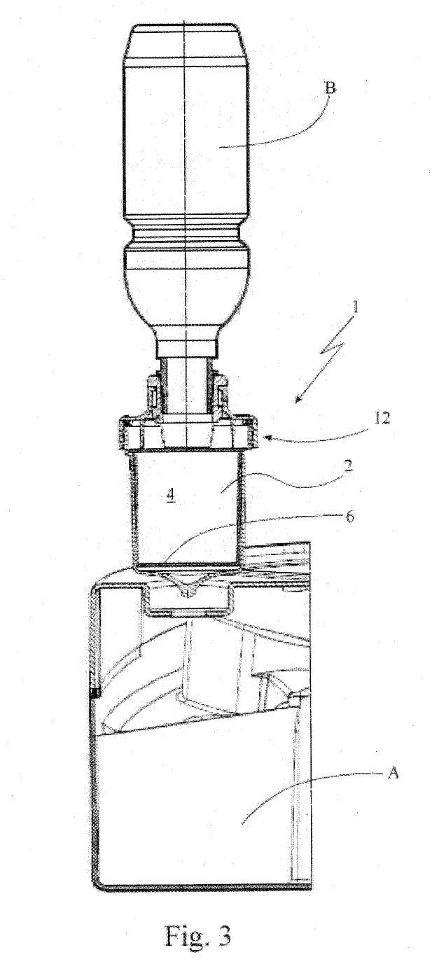

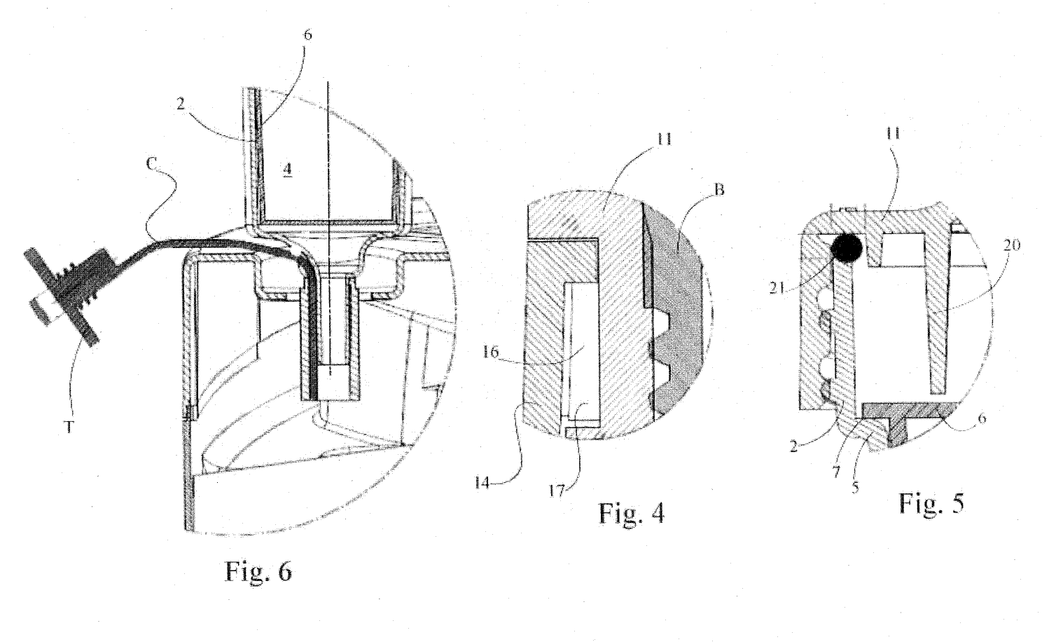

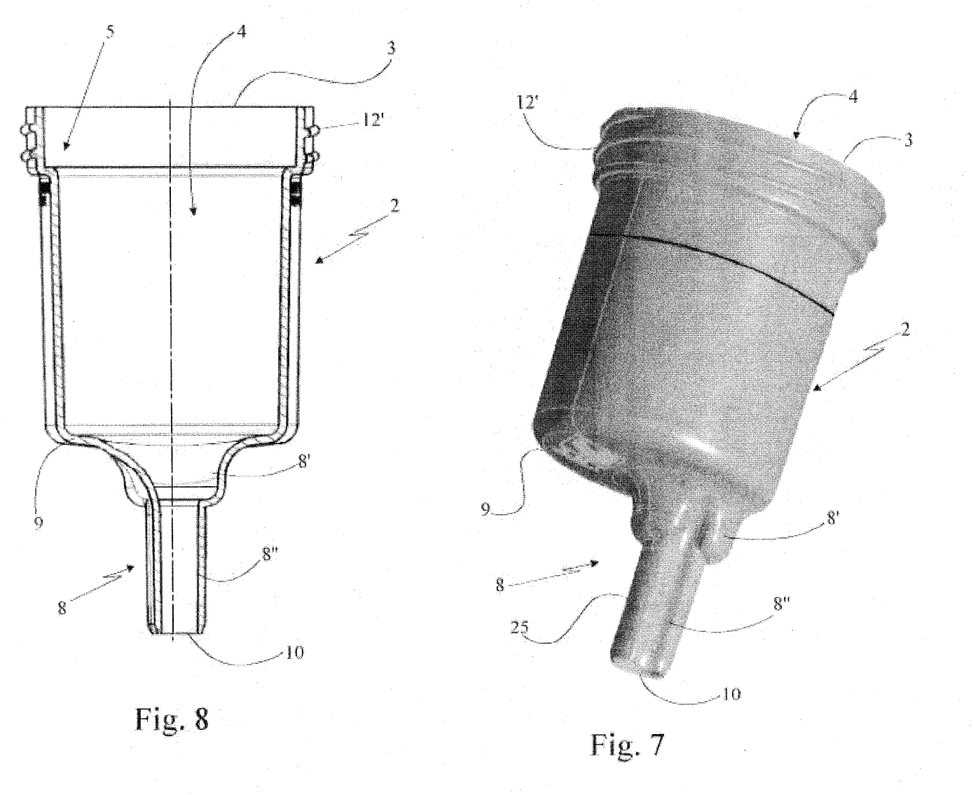

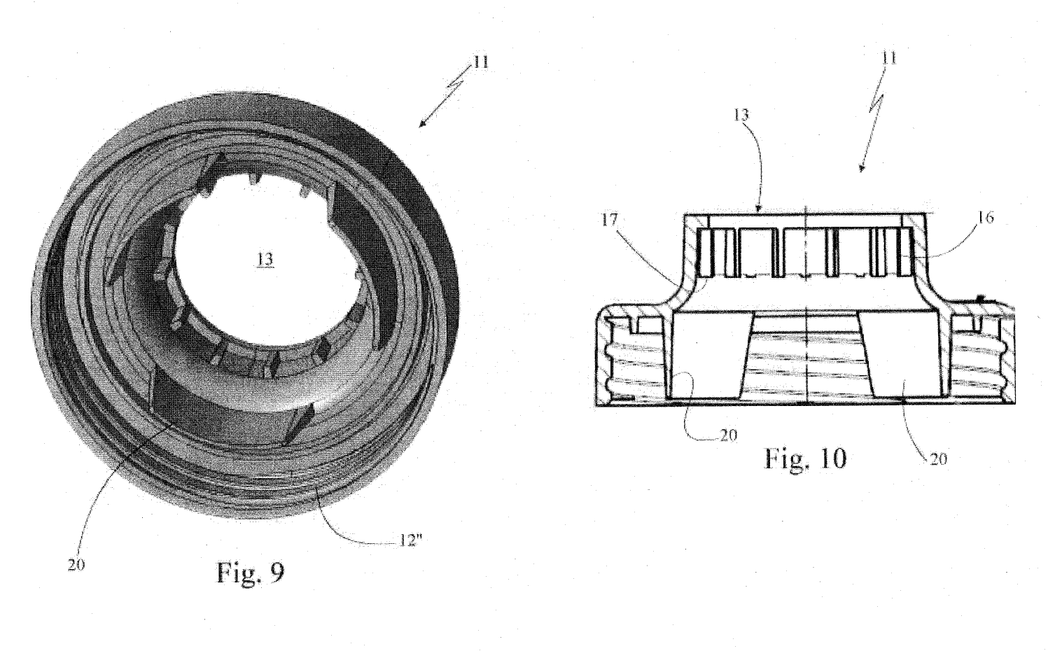

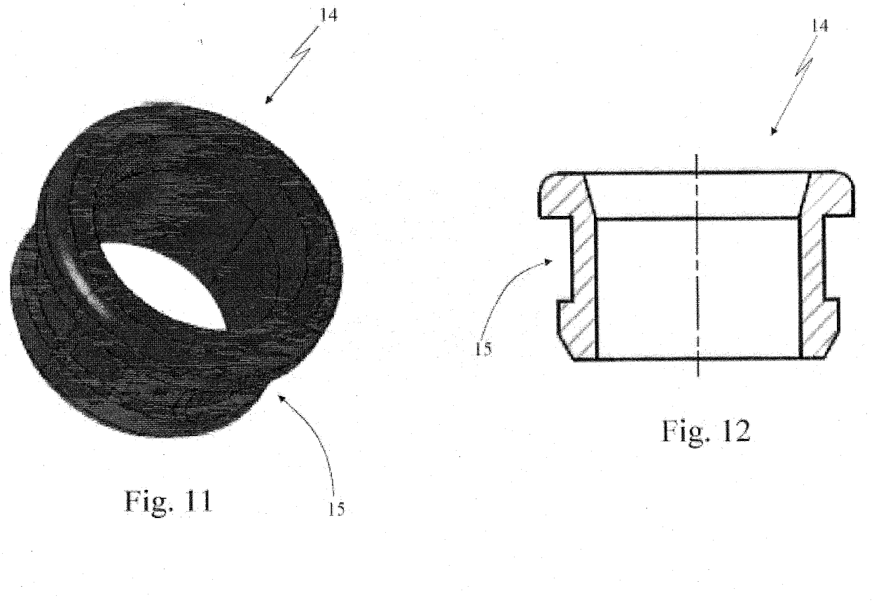

Such seal (14) doubles as an adaptor because it is elastic allowing for a watertight seal around the top of various sized bottles (B) turned up-side down on the filter as indicated in particular in FIGS. 1 to 3. In this way, the filter is easily supplied and it is consequently possible to fill, at the same time, the tank of the appliance (A) on which the filter (1) is fitted.

More specifically, the seal (14) has an external hollow ring (15) able to hold a protruding ring (16) on the internal surface of the lid (11) near the opening (13).

The protruding ring (16) of the lid (11) is placed between its higher edge and an undercut (17), protruding and in particular comprising of radial finnings.

During operation, when the channel (8) is inserted in the opening of the tank of the appliance (A) to be used, the container (2) rests on the bottom on the mouth of the opening interlocking with the higher portion (8′) of the channel (8) in order to support the filter (1) as well as the bottle (B) inserted up-side down in the opening of the lid (11) and held by the seal (14).

The channel (8) has the added advantage of including a longitudinal hollow (25) that interrupts the regularity of the section of the channel (8) in order to expel the air when the filter (1) releases the water into the tank of the appliance (A).

The same hollow (25) provides the location for a cord (C) attached to a closing cap (T) of the tank of the appliance (A), if applicable.

The invention as conceived achieves the aims that had been set.

Obviously, the implementation of the invention can take on, during its realisation, shapes and configurations that differ from those described above without leaving the area of protection of this patent.

Furthermore, all the details can be replaced by technically equivalent elements and the dimensions, shapes and materials used can be selected according to requirement.

1. Advanced filter for boilers, in particular for domestic appliances such as irons, steam generators, humidifiers or other elements characterised in that it comprises:
a container with an opening, a compartment able adapted to receive a Filtering cartridge in a seat at its interior, of an elongated hollow section, linked to said compartment, forming a channel extending from the bottom of said container downstream of said filtering cartridge, comprising an opening for the exit of demineralised liquid at the free end;
a removably associable closing lid connected to the opening of the container, with an opening to introduce the liquid into said container.

2. Filter according to claim 1, characterised in that it comprises a seal in rubber or other similar material formed by a hollow ring anchored to the lid within the mouth of the opening and able to hold the top of a container; in particular that of a bottle.

3. Filter according to claim 2, characterised in that said above seal has an external hollow ring able to hold a protruding ring on the internal surface of the lid near the opening and placed between its higher edge and an undercut, protruding and in particular formed by radial finning.

4. Filter according to claim 1, characterised in fact that said elongated section is able to be inserted in the opening of said appliance as long as the border of the latter fits and is seated on the external surface of the bottom of said container.
